(19) United States
(12) Patent Application Publication
(10) Pub. No.: US 2017/0224150 A1
(43) Pub. Date: Aug. 10, 2017

(54) IMPROVED FILTER FOR ESPRESSO COFFEE MACHINES

(71) Applicant: Giancarlo BRUN, Thiene (vi) (IT)

(72) Inventor: Giancarlo BRUN, Thiene (vi) (IT)

(21) Appl. No.: 15/502,167

(22) PCT Filed: Jul. 31, 2015
(86) PCT No.: PCT/IB2015/055824

§ 371 Date: Feb. 6, 2017

(30) Foreign Application Priority Data
Aug. 5, 2014 (IT) VI2014A000208

(51) Int. Cl. A47J 31/08; B65D 65/46

(52) U.S. Cl. CPC A47J 31/085; B65D 65/466

(57) ABSTRACT

An improved filter (1) for espresso coffee machines (M) including a rigid main filtering containment and/or support body (20), suitable to be coupled with a support element belonging to an espresso coffee machine (M) and shaped to define an inner seat (21) suitable to receive powder coffee, as well as, a disposable middle filtering containment and/or retaining insert (10) made of food use material, removably coupled with the rigid main filtering body (20) by means of at least partly insertion into the inner seat (21), shaped as to define an inner space (11) suitable to receive the powder coffee to be used in preparing espresso coffee by means of leaching of hot water, avoiding contact between the powder coffee and the main filtering body (20), provided with a laminar filtering bottom (14) in which separation means (18) are defined suitable to favour passing of a coffee infusion.

The present invention refers to the field of the preparation of coffee, in particular, of the preparation of espresso coffee using machines supplied at commercial public shops (bars, restaurants, hotels and so on), mocha-type coffee makers, vending machines, automatic machines and/or the like.

In detail, the present invention relates to a technical solution that allows to simplify and improve the operations of preparation of the coffee of the aforesaid type.

Even more in detail, the present invention concerns an element, such as an improved filter, to be used in the preparation of the coffee of the above type by means of espresso coffee machines, as well as a filtering kit and a methodology for preparing coffee of the type indicated above which, respectively, comprise and use such an improved filter.

As known, coffee preparation requires a particular care about the cleaning of the coffee machine, in particular of its component parts that, during the preparation of the coffee, must necessarily come in contact with the powder coffee.

This applies in particular both in the case of espresso coffee machines for bars, restaurants or commercial shops in general, and in case of coffee appliances of household type, such as the mocha-type coffee makers, “Neapolitan” coffee makers or similar.

Indeed, it is known that, in order to get a coffee of good quality and aroma, it is necessary to carefully clean, after every preparation, the parts of the machine or coffee maker that, during the preparation itself, have touched the powder coffee, so as to carefully remove the organic residues, commonly known as coffee wastes, which remain somehow attached to them.

For example, in the case of espresso coffee, it is not sufficient to simply empty the filter, but it is necessary to thoroughly clean the filter itself, for example by means of a brush, in such a way as to remove any possible organic residue (coffee wastes).

Moreover, other component parts of the machine (such for instance the support assembly of the filter housing the powder coffee or the support element—called shower—belonging to the espresso coffee machine), even if they are not in direct contact with the powder coffee, must be regularly washed with extreme care.

It is, indeed, proved that possible residues of coffee wastes, if not carefully removed, adversely affect not only the quality of the coffee prepared through the next operation, but also the proper functioning of the machine itself (for example by occluding the filter). It must be also considered that the organic residues resulting from the preparation of espresso coffee (wastes), if they come into contact again with the preparation water (at high temperature, typically about 90° C., and pressure) may even release toxic and harmful to the consumers' health substances.

It is, therefore, unavoidable that the cleaning operations, if carried out correctly in accordance with recommendations, if not even regulations, involve problems of a certain importance due to the fact that they length coffee preparation time, whereas on the contrary, especially in case of bars or restaurants, especially during peak hours of inflow of clients, it would be preferable for the operators to reduce as far as possible preparation times.

In consideration of the above problems, in the recent past, solutions have been proposed aimed at avoiding as much as possible the operations of cleaning of the coffee machine and/or its component parts, in particular of the filter and/or the support group of the filter: for example, solutions have been proposed involving the use of closed disposable waffles or capsules, ready for use, made of different materials and filled with powder coffee.

Waffles for coffee preparation are in particular inserted into a suitable seat or support of the machine, and are designed so that, during preparation of coffee, the powder coffee contained into them is sprayed with the hot water and/or steam generated by the machine.

However, even the waffles or capsules of the aforementioned type, although very practical and effective in reducing coffee preparation time because they considerably limit the frequency of cleaning of the parts involved in the coffee machine—such as filter, filter support assembly and/or the like—have some recognized drawbacks.

First of all, the waffles of the aforesaid type are not so appreciated by the operators of bars, restaurants or commercial public shops in general, since the customers decidedly prefer a coffee prepared according to as much as possible traditional modes, in particular by means of coffee middle in real time and thus fresh, freshly made up for use, while the coffee waffles unfavorably contains preservatives and is sealed.

Moreover, coffee waffles present a certain complexity of production, since it is necessary sealing them under and over, practicing micro-holes in order to facilitate the release of the coffee infusion, providing an inner tissue which prevents the leakage of the powder coffee from the micro-holes in the bottom of greater capacity. Furthermore, waffles are usable only in automatic machines operating at low pressure (1-1.5 bar).

In addition, in case of the preparation of coffee for domestic use, the selling price of the waffles of the abovementioned type make its use impossible for the public and/or however not convenient from the economic point of view.

Furthermore, it happens that the waffle, being made of plastic material and/or aluminum, in contact with steam and subjected to pressure in the related espresso coffee machine, releases harmful substances, with the obvious relevant disadvantages that this determines.

Finally, waffles made of materials such as aluminum or similar materials, however non-biodegradable materials, are difficult to dispose of since they cannot be disposed of together with biological and/or biodegradable materials (together with the so-called compostable “green waste”), according to the rules in law on the waste separation.

Another drawback linked to the cleaning of the coffee machines, in particular espresso coffee machines but not only, derives from the fact that, in order to empty the support assembly of the filter, the operator—manager of a bar or end user at home—must shake fairly vigorously; for example, it is known that in case of coffee machines for bars, restaurants and commercial shops in general, the filter is emptied by vigorously beating the support assembly of the filter on the appropriate drawer containing coffee wastes.

This operation is, however, noisy and also involves the risk of damage (in particular warping), the filter and/or the support assembly of the filter or even possibly the drawer containing the coffee wastes, with the obvious disadvantages that this entails.

Furthermore, it is widely demonstrated that the emptying operation of the filter in the manner just described involves the risk of serious trauma to the arm of the operator, in particular of the bartender entrusted to frequently and repeatedly perform it during the same day.

The present invention aims to overcome the drawbacks of the current state of the technique just highlighted.

In particular, main purpose of the present invention is to propose an innovative solution that allows to simplify and/or speed over the prior art the operations of preparing espresso coffee, whether prepared with professional machines for espresso coffee or with mocha-type coffee makers, avoiding or at least minimizing the cleaning of the coffee machine and/or of its component parts and, at the same time, still allowing the use of powder coffee if not milled in real time at least not pre-packaged in disposable (or use-and-throw-away) packages or doses such as typically waffles, capsules or the like.

Within this purpose, it is task of the present invention to provide an improved filter for espresso coffee machines whose innovative solution can be implemented by means of espresso coffee machines and/or coffee-makers of the known type which do not provide for the use of waffles and without the need to make any constructive modification to them, nor to make available special machines and/or coffee makers, specifically designed or dedicated. It is another purpose of the present invention to devise an improved filter for espresso coffee machines which is of easy and immediate use and that involves possible minimal additional and/or substantially negligible costs.

It is a further purpose of the invention to create an improved filter for espresso coffee machines, initially intended to contain powder coffee, which, compared to the current situation, can be emptied from the organic residues (or coffee wastes), resulting from its infusion, by means of simpler operations and definitely less tiring and/or noisy, in particular without the need to shake and/or knock the filter and/or the filter support assembly on the containment drawer present in a public shop or in a house with the purpose of waste collecting, as it happens in the prior art.

As part of this purpose, it is task of the invention to safeguard greater than the prior art the physical health of those operators that within a working day are appointed to prepare with relevant repetition and frequency espresso coffee in commercial public shops, reducing with respect to the current state of the technique the risk of possible trauma to the arm even of a certain entity.

Always in the cognitive sphere of the last purpose just cited, it is a second task of the invention to make available an improved filter for espresso coffee machines which eliminates or at least considerably reduced, compared to the known art, the risks of damage (in particular, deformation) of the filter itself, of the filter support assembly and/or of the drawer of containment of the organic residues (coffee wastes) associated with the preparation of espresso coffee.

It is a last but not least purpose of the present invention to propose an improved filter for espresso coffee machines which can be conveniently and easily disposed of together with coffee wastes according to the manners provided for the disposal of biodegradable and/or organic waste, in accordance with the rules in force concerning waste separation.

Said purposes are achieved by means of an improved filter for espresso coffee machines according to claim 1 hereto, as hereinafter referred for the sake of brevity of exposure.

More technical detail features of the improved filter for espresso coffee machines of the invention are contained in the corresponding dependent claims.

Also a filtering kit contributes to obtain the aforesaid purposes, integral part of the present invention, according to attached claim 18, as again hereinafter referred for the sake of exposure brevity.

The above-mentioned claims, hereinafter specifically and concretely defined, shall be meant as integral part of the present description.

Advantageously, in view of the purposes listed above, the present invention is based on the general concept of avoiding contact between the powder coffee and the parts of the machine or coffee maker canonically intended to contain it, represented by rigid and/or metallic filters or the like, and thus of avoiding formation or even partial deposit of organic residues (coffee wastes) on these parts of the machine.

In particular, the present invention is based on the further consideration according to which the contact between the powder coffee and the abovementioned parts of the machine or coffee maker is effectively avoided by interposing between the parts of the machine or coffee maker themselves (traditionally delegated to contain the powder coffee) and the same powder coffee a disposable intermediate containment and/or retaining filtering element or insert suitable to protect and/or shield the aforesaid parties while still allowing the passage of the liquid coffee, in particular the coffee infusion obtained by leaching of hot water.

In practice, according to the main aspect of the invention, in order to achieve the purposes set above, the powder coffee is not inserted directly into the rigid main filtering containment and/or support body, generally made of metallic material, as it currently happens: at contrary, in such a rigid main filtering body is previously placed the aforesaid disposable intermediate filtering containment and/or retaining (or screen) insert actually intended to receive the powder coffee according to the same methods provided at the state of the art for placing powder coffee into the main filtering body.

In this way, it is advantageously and effectively prevents contact between the powder coffee and the main filtering containment body, and therefore the possible formation of damaging, harmful and still undesirable organic residues (coffee wastes) on it.

Still advantageously, the present invention allows to empty the improved filter for espresso coffee machines in a decidedly simpler way than what can be found in the prior art because the improved filter of the invention can be completely emptied from the organic residues resulting from the preparation of espresso coffee simply by overturning it, for example by rotating it of 180°, in any waste receptacle, such as for instance the drawer of a bar below the professional coffee espresso machine.

Equally advantageously, therefore, the aforesaid disposable intermediate filtering insert of the improved filter of the invention is made of a material for food and, according to a preferred embodiment of the invention, in a properly biodegradable material, so that such a disposable insert, overturning the improved filter of 180°, can be left freely falling into a tray waste containment drawer (being coupled in a purely removably way with the main filtering containment body) while still containing the organic residues of the preparation of espresso coffee in order to be easily disposed of together with them.

Equally advantageously, thanks to the disposable intermediate filtering containment and/or retaining (and/or screen) insert of the improved filter of the present invention, the traditional rigid main filtering body could be completely emptied (without restraining harmful and undesired residues) by simply overturning it; indeed, the presence of such a disposable intermediate filtering insert, by avoiding contact between the coffee wastes and the rigid main filtering body, eases detachment of the funds, without the necessity to shake or beat the filtering body itself and/or the support assembly of the improved filter of the invention, and therefore without problems of noise and/or trauma for the operator (bartender or end user, for example at home).

Said purposes and advantages, as well as other ones that will emerge hereinafter, will appear to a greater extent from the detailed description which follows, relating to preferred embodiments of the improved filter for espresso coffee machines of the invention, given by indicative and illustrative, but not limitative, way with reference to the accompanying drawing tables in which:

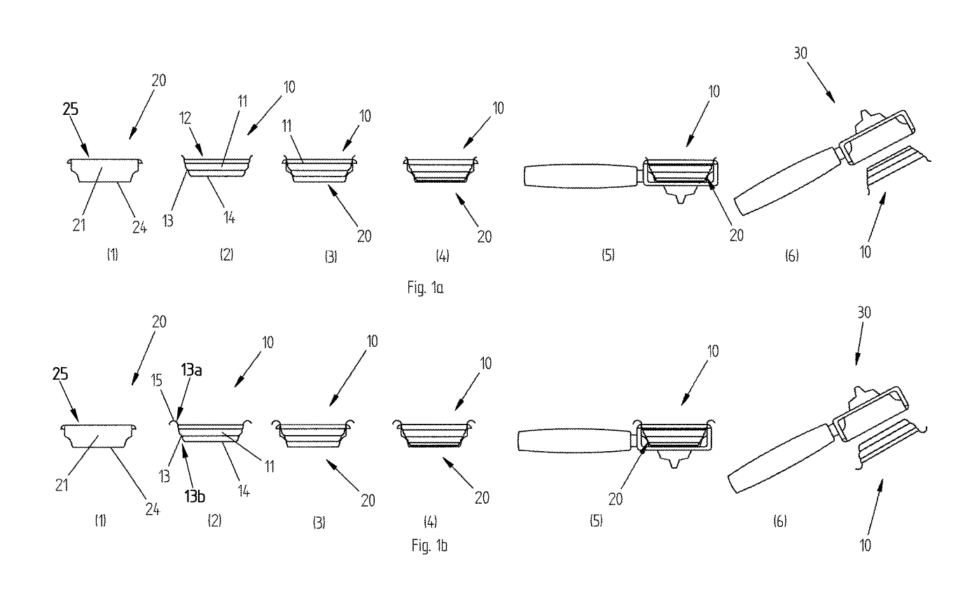

FIGS. 1a, 1b, 1c and 1d are each relating to a disposable (or “use-and-throw-away”) intermediate filtering insert according to one embodiment of the improved filter of the present invention and to a method for the preparation of espresso coffee using professional machine for commercial public shops;

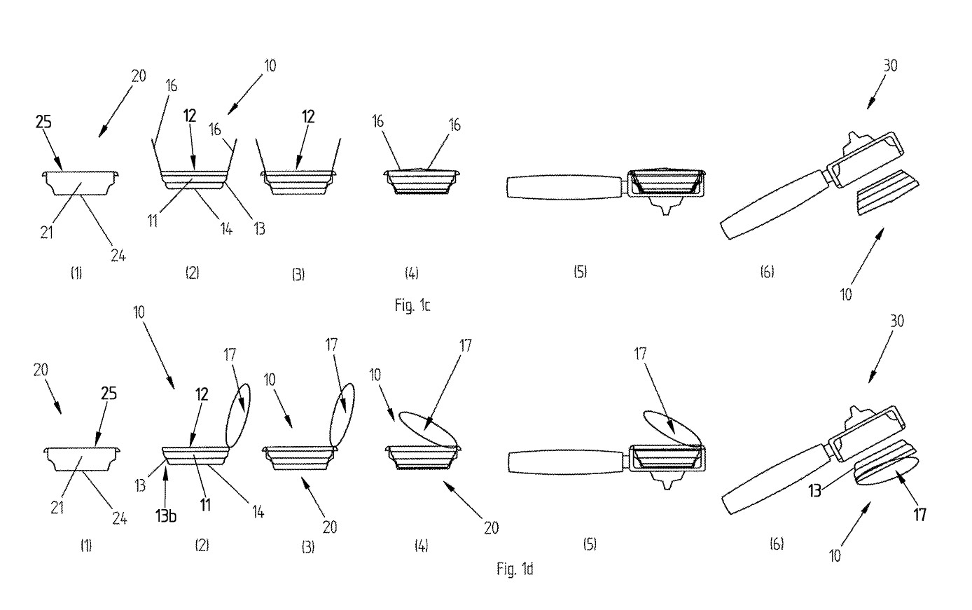

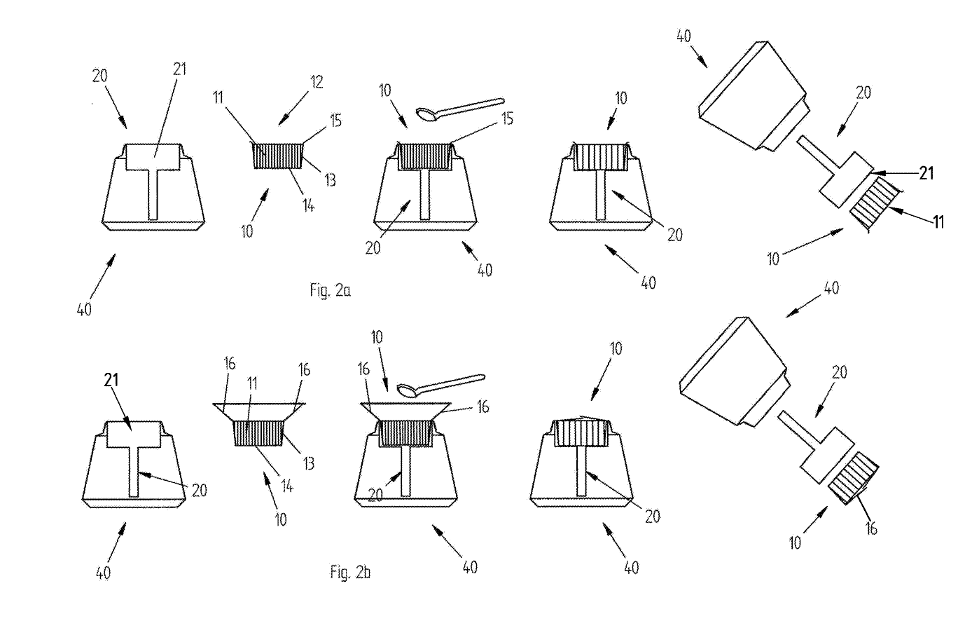

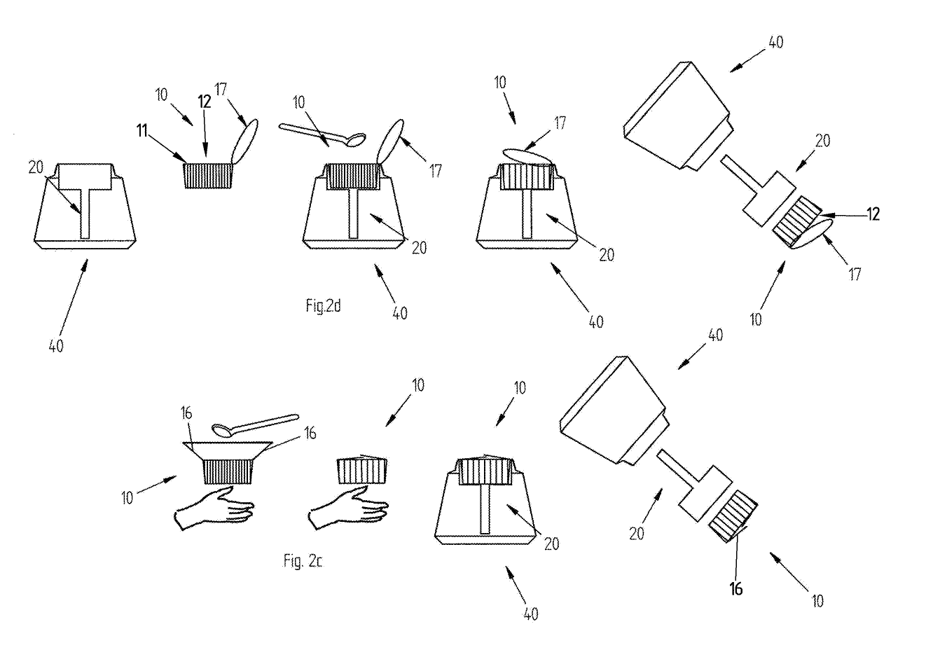

FIGS. 2a, 2b, 2c and 2d are each relating to a disposable (or “use-and-throw-away”) intermediate filtering insert according to one embodiment of the improved filter of the present invention and a “home” method for the preparation of espresso coffee, in particular mocha type espresso coffee;

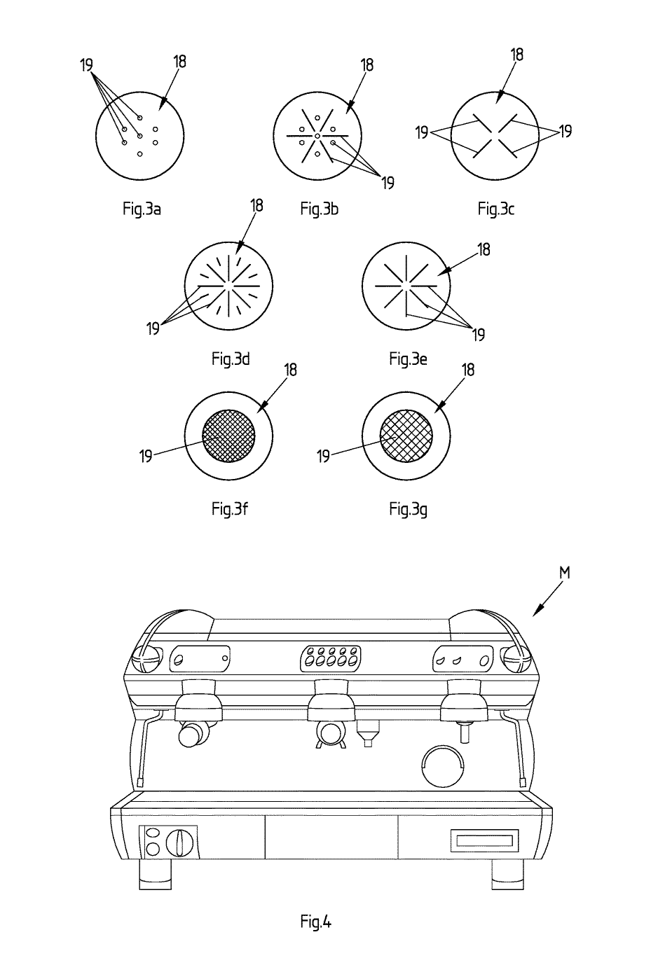

FIGS. 3a, 3b, 3c, 3d, 3e, 3f, 3g are different plan views from below of as many different embodiments of a constructional detail—namely, the disposable intermediate filtering insert—of the improved filter of the invention;

FIG. 4 is a schematic and simplified front view of a coffee machine adapted to receive one or more support assemblies of the improved filter of the invention;

FIG. 5 is a simplified side view of a further embodiment of the improved filter of the invention;

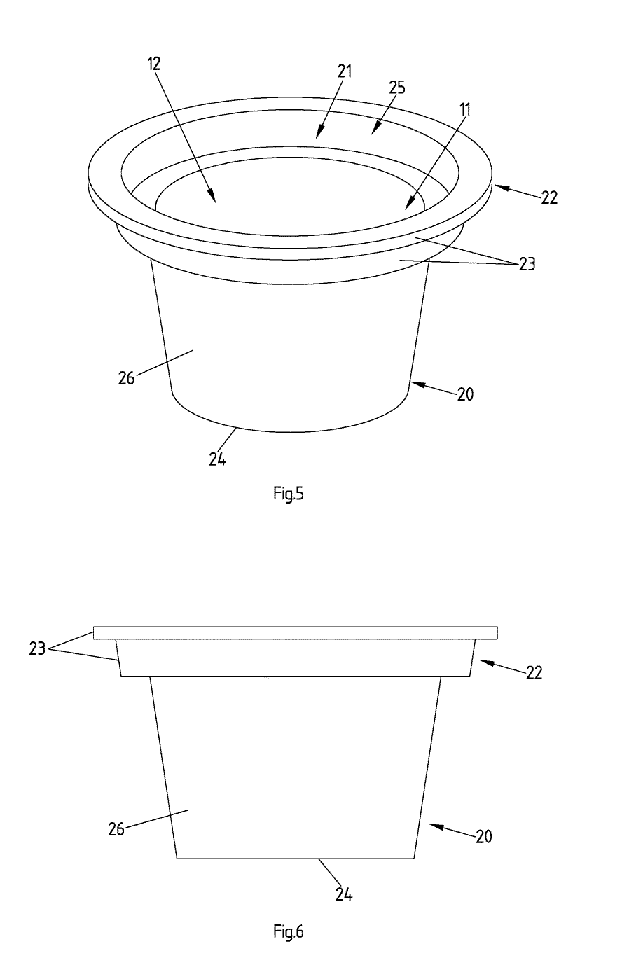

FIG. 6 is the assonometric view of a constructive detail of FIG. 5;

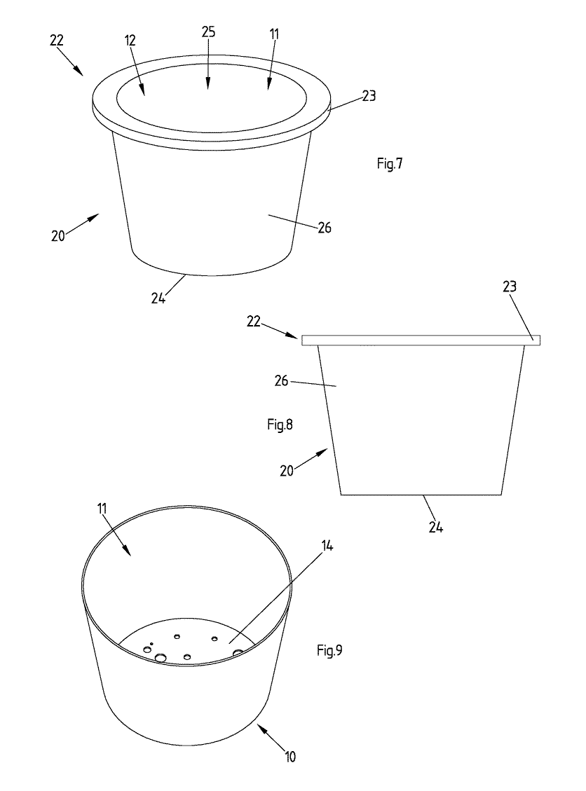

FIG. 7 is the simplified side view of a further embodiment of the improved filter of the invention;

FIG. 8 is the assonometric view of a constructive detail of FIG. 7;

FIG. 9 is the assonometric view of a constructive detail—namely, disposable intermediate filtering insert—of the improved filter of FIGS. 5 and 7.

The present invention finds particular and effective application in the field of the preparation of espresso coffee, that is to say of the coffee prepared using professional coffee machines, coffee makers for domestic use, such as for instance mocha-type coffee makers, automatic machines, automatic vending machines and/or the like; then, this is the reason why in the following, the present invention will be described with particular reference to the preparation of espresso coffee of the aforesaid types.

In any event, the present invention is not limited to the preparation of coffee of the aforesaid types; on the contrary, the innovative concept of the invention finds as effective and advantageous application in all those cases in which the preparation of espresso coffee according to the known methods provides for contact between the component parts of the machine coffee professional or coffee maker and powder coffee and in which it doesn't want to give up the use of powder coffee, if not freshly milled at least not contained in prepared packages or doses, such as typically waffles or capsules are in general.

In FIG. 1a, reference numbers 30 and 20 identify, respectively, a support assembly of the improved filter, the latter object of the invention and indicated with 1 in the following, and the rigid main filtering body of the professional machines of common type used in preparing espresso coffee for instance in bars or similar public premises but also for home use.

For the preparation of espresso coffee according to the known methods, the support assembly 30 with the main filtering body 20 positioned in its proper seat is applied to a support element belonging to an espresso coffee machine (represented in FIG. 4 in a schematic way where it is indicated with M) in the position shown in FIG. 1a (5), that is to say with the rigid main filtering body 20 (usually made of metallic material) facing upwardly so that the powder coffee contained therein is sprayed from the top, by leaching, with the hot water and/or steam generated by the machine M, and therefore in such a way that the infusion of coffee overflows from the lower part of the support assembly 30.

According to the invention, the improved filter 1 includes a disposable intermediate filtering containment and/or retaining (or screen) insert 10, made of food use material, having a shape substantially corresponding to that one of the rigid main filtering body 20 and dimensions such that it can be housed at least partly in the inner seat 21 of the rigid main filtering body 20 usually intended to contain the powder coffee.

In its essentials and basic lines, therefore, the improved filter 1 for espresso coffee machines M includes the rigid main filtering containment and/or support body 20 suitable to be coupled with a support element belonging to the espresso coffee machine M and shaped in such a way as to define the inner seat 21 suitable to receive powder coffee.

In accordance with the invention, the improved filter 1 also includes a disposable intermediate filtering containment and/or retaining insert 10 made of food use material and:
removably coupled with the rigid main filtering body 20 by means of insertion, in this case almost complete, into the inner seat 21;
shaped in such a way as to define an inner space 11 suitable to receive the powder coffee to be used for the preparation of espresso coffee by leaching of hot water, thus de facto avoiding the contact between the powder coffee and the main filtering body 20;
provided with a laminar bottom 14 in which separation means are defined, better visible in FIGS. 3a-3g in some of their possible embodiments, where they are numbered as a whole with 18, suitable to favour passing of a coffee infusion produced by means of the aforesaid leaching of hot water;
suitable to be placed close to the support element of the espresso coffee machine M in such a way as to be interposed between the main filtering body 20 and the support element itself of the espresso coffee machine M.

The intermediate disposable filtering insert 10 comprises, in particular, a laminar filtering bottom 14 and a laminar side wall 13 which extends upwardly from the outer peripheral edge of the laminar bottom 14 in such a way as to define, with the laminar bottom 14, an inner space 11 suitable to contain powder coffee according to the quantity provided by the modes of coffee preparation (for example, seven grams in case of a single dose of espresso coffee referred to in the attached figures, or fourteen grams in case of a double dose of coffee).

In the embodiment shown in FIG. 1a, the laminar side wall 13 is tighten-tapered towards the laminar bottom 14 in such a way as to confer to the intermediate filtering insert 10 a frusto-conical shape substantially coincident with that one of the (usually metallic) rigid main filtering body 20.

It is highlighted that the shape of the disposable intermediate filtering insert 10 may vary depending on the needs and/or circumstances, in particular depending on the shape of the rigid filtering body 20 of the espresso coffee machine M.

The disposable (or use-and-throw-away) intermediate filtering insert 10 could be made of different materials for food use, for example paper, in particular of cellulose, fabric, whereas the use of natural materials is preferable because it allows a convenient and healthy disposal of the disposable filtering insert 10 itself.

More preferably and generally, the food use material, which the disposable intermediate filtering insert 10 is made with, is biodegradable, compostable and/or disposable as organic waste according to regulations in law regarding waste separation.

Even more in particular, such a food use material is any plastic material for foods selected from the group consisting of recyclable bioplastic material, polylactic acid (PLA), low density polyethylene (LDPE), polyethyleneterephthalate (PET), polyvinylchloride or chloride of polyvinyl (PVC), vinylester resins, silicone, elastomer, combinations thereof and/or similar. For example, the recyclable bioplastic material could be a completely biodegradable and compostable bioplastic, compliant to standard In13432, resistant to liquids, fatty foods, cold as well as the temperatures that develop during preparation of espresso coffee in the professional machine M: such a bioplastic material is commonly known by the trade name of Mater-bi® (registered trademark).

Preferably but not necessarily, the disposable intermediate filtering insert 10 presents an infinitesimal thickness, such that the dose of powder coffee which can be contained into the inner space 11 takes a value universally recognized as necessary for giving acceptable quality to the espresso coffee (seven grams in case of a single dose of espresso coffee, fourteen grams in case of a double dose of coffee, as already indicated above).

In substance, anyway, the thickness of the disposable intermediate filtering insert 10 of the improved filter 1 must take a value that allows to achieve an effective compromise between the following properties:
ability to withstand, without deformation for dilatation, the temperatures into play in preparing espresso coffee through coffee machines M of professional or domestic type;
defining an inner space 11 capable of housing the minimum correct dose to get a quality espresso coffee;
allowing the passage of the coffee infusion;
competitive production costs.

By way of preferred but not limiting title, it is stated precisely that the thickness of the disposable intermediate filtering insert 10 which allows to reach such properties is set at about 400 μm, in case in which the biodegradable material for food use consists of Mater-bi® or similar.

In order to allow a precise adaptation of the disposable filtering insert 10 to the rigid filtering body 20 of the coffee machine M, the disposable filtering insert 10 could also include, in a preferred but not bounding way, a plurality of pleats and/or wrinkles, made in particular in the laminar side wall 13, which will allow to easily adapt the dimensions and shape of the disposable filtering insert 10 to those ones of the rigid filtering body 20.

Furthermore, also the laminar bottom 14 of the disposable filtering insert 10 could have a shape corresponding to that one of the bottom 24 of the rigid filtering body 20; for example, the laminar bottom 14 could be flat in case also the bottom 24 of the filtering body 20 is flat, or could be concave or convex in case the bottom 24 of the filtering body 20 is, respectively concave or convex.

In the embodiment of FIG. 1a, the inner space 11 defined by the disposable filtering insert 10 (properly suitable to receive the powder coffee) communicates with the outside through an inlet mouth 12 that allows both to introduce the powder coffee in the inner space 11 and to spray the powder coffee by means of leaching of hot water and/or steam produced by the coffee machine M according to the procedures described in detail below.

The sequence of steps (1) to (6) of FIG. 1a represents one of the possible sequences of coffee preparation according to the methodology of the present invention.

As shown, during step (3) subsequent to steps (1) and (2) of preparation of the rigid main filtering body 20 of the coffee machine M and of the disposable intermediate filtering insert 10 of the improved composite filter 1 of the invention, insertion of the disposable filtering insert 10 into the inner seat 21 of the rigid filtering body 20 is performed.

Subsequently, during step (4), the powder coffee is introduced into the inner space 11 of the disposable filtering insert 10, and then, during step (5), the rigid filtering body 20, complete with disposable filtering insert 10 contained therein, it is inserted into the seat of the support assembly 30 provided for that purpose.

The next step, not shown, provides for the application of the support assembly 30 to the coffee machine M according to known methods and the actual preparation of the coffee, where the hot water and/or steam generated by the coffee machine M spraying from the top the powder coffee contained into the disposable filtering insert 10 and where the liquid coffee (in the form of coffee infusion) comes out from the lower part of the support assembly 30 passing through both the laminar bottom 14 of the disposable filtering insert 10 and the bottom 24 of the rigid filtering body 20.

The final step (6) of the process provides for emptying the rigid filtering body 20: this could be done simply by overturning the support assembly 30 of the improved filter 1 of the invention, without any need to shake and/or beat it (for example on the edge of drawer containing organic compounds—or coffee wastes—below the professional machine M used in bars, restaurants and/or commercial shops in general), so that the coffee wastes contained into the inner space 11 of the disposable filtering insert 10 are in this way placed in an appropriate container together with the disposable filtering insert 10 itself without the risk that they remain disadvantageously attached to the rigid filtering body 20, as occurs in the known art.

On the contrary, thanks to the technical invention, the rigid filtering body 20 is perfectly clean whereby, in order to proceed to the preparation of the next coffee, those operations of cleaning of the rigid filtering body 20 that must be performed to still get a coffee of adequate and required quality will be not necessary.

In the invention, after the preparation of an espresso coffee, the rigid filtering body 20 remains, indeed, depict of organic residues (coffee wastes) and/or various crusts: it follows that the preparation of the next espresso coffee could therefore start properly, following the sequence of operations just described, without any delay or loss of time by the operator to perform cleaning of the rigid filtering body 20, as it happens instead (or at least is recommended to happen) in the known art.

Obviously, the sequence of operations from (1) to (6) is subject to variation, according to the needs and/or circumstances; for example, steps (3) and (4) could be changed, by preceding the step of inserting the disposable filtering insert 10 into the rigid filtering body 20 with the step of filling the disposable filtering insert 10 with the powder coffee.

In the following, with reference to FIG. 1b, an improved filter 1 of the present invention, complete with disposable intermediate filtering insert 10 and the rigid main filtering body 20, is described according to a further preferred but not exclusive embodiment; in FIG. 1b, component parts and/or features and/or steps of the procedure already previously described with reference to FIG. 1a are identified by the same numerical references.

The main difference between the embodiment of FIG. 1b of the improved filter 1 and that one of FIG. 1a yet described comes from the fact the disposable filtering insert 10 of FIG. 1b, preferably, includes, in the specific case, also a portion of perimetrical extension 15 that:
extends from an upper edge 13a of the laminar side wall 13 opposite to a lower edge 13b connected with the outer perimetrical edge of the laminar bottom 14 which in particular is preferably made in a single body with;
is foldable towards the outside in such a way as to be superimposed to the outer edge of the rigid main filtering body 20 and extend at least partly outside the rigid filtering body 20 itself (step (4)) or, possibly, even at least partly outside of the support assembly 30 (step (5)) of the improved filter 1 and thus operate as sealing gasket when the improved filter 1 is in operating conditions, placing itself hermetically close to the support element (so-called “shower”) of the espresso coffee machine M.

More in detail, the portion of perimetrical extension 15 can be folded along weakening means, not shown for the sake of explanation simplicity in the accompanying drawings and comprising, for example, a track of preferential folding: they are arranged at the upper edge 13a of the laminar side wall 13.

Steps (1) to (6) of the method of FIG. 1b therefore substantially coincide respectively with those ones (1) to (6) of the method of FIG. 1a, with the only difference that in this case one of the steps (3), (4) or (5) of the method of FIG. 1b provides for the additional operation of folding towards the outside of the portion of perimetrical extension 15 of the disposable intermediate filtering insert 10.

In the following, with reference to FIG. 1c, another version of the improved filter 1 of the invention, complete with disposable intermediate filtering insert 10 and rigid main filtering body 20, is described: in FIG. 1c, component parts and/or features and/or steps of the procedure already described above with reference to the other FIGS. 1a and 1b are identified by the same reference numerals.

The main difference between the embodiment of FIG. 1c of the disposable insert 10 and those ones of FIGS. 1a and 1b refers to the fact that the laminar side wall 13 of the disposable filtering insert 10 of FIG. 1c comprises in this case two portions, in particular a perimetrical proximity portion extending upwardly from the outer perimetrical edge of the laminar bottom 14 and a perimetrical end portion 16 which extends from the perimetrical proximity portion with respect to which is movable between a closure position in which it substantially closes the inner space 11 of the filtering insert 10 and an opening position in which such an inner space 11 communicates with the outside through the inlet mouth 12, thus being ready to house the powder coffee to be used for the preparation of the espresso coffee.

Preferably but not necessarily, the perimetrical end portion 16 is punched in order to allow passage of water for preparing the coffee infusion.

In particular, the laminar side wall 13 comprises weakening means, not accompanied by numerical reference for the sake of simplicity, along which the perimetrical end portion 16 can be folded alternately between the closure position and the opening position with respect to the perimetrical proximity portion.

For example, the weakening means include a track of preferential folding made in the laminar side wall 13 and foldable inwardly in such a way as to close at least partly (for example during step (4)) the inner space 11 of the disposable filtering insert 10 subsequently to the introduction of the powder coffee into the inner space 11.

Steps (1) to (6) of the method of FIG. 1c therefore substantially coincide respectively with steps (1) to (6) of the method of FIG. 1a, with the only difference due to the fact that one of the steps (3), (4) or (5) of the method of FIG. 1c provides for the additional operation of folding inwardly the perimetrical end portion 16 of the disposable filtering insert 10.

The most remarkable advantages of this embodiment with respect to the embodiments already described above can be summarized as follows:
the perimetrical end portion 16 on one hand facilitates the filling of the disposable filtering insert 10 avoiding spillages or unwanted losses of powder coffee from the latter (being in this case the inner space 11 wider than in the previous cases) before the application of the support assembly 30 of the improved filter 1 to the coffee machine M;
the other hand, the perimetrical end portion 16 allows that the filtering of the hot water of preparation also takes place through the perimetrical end portion 16;
the perimetrical end portion 16 prevents contact between the powder coffee and the parts of the coffee machine M positioned above the powder coffee during preparation of coffee, thus avoiding that these parts get dirty or become contaminated by the organic residues involved (or coffee wastes).

In the following, with reference to FIG. 1d, a further embodiment of the improved filter 1 of the invention, complete with disposable intermediate filtering insert 10 and rigid main filtering body 20, is described: in FIG. 1d, component parts and/or features and/or steps of the procedure already described above with reference to the other figures so far cited are identified by the same reference numerals.

The main difference between the embodiment of FIG. 1d of the disposable filtering insert 10 and those ones of FIGS. 1a, 1b and 1c is related to the fact that the disposable filtering insert 10 of FIG. 1d includes a foldable lug or flap 17 (basically, a cover) having shape and dimensions substantially corresponding to those ones of the inlet mouth 12.

The foldable flap 17 extends from the upper edge 13a of the laminar side wall 13 opposite to the lower edge 13b connected with the laminar bottom 14, and this in such a way as to be folded or closed (possibly along a track of preferential folding made for example near the outer perimetrical edge of the laminar side wall 13) towards the inside between a position of opening (FIG. 1b (3) and (4)) in which the inner space 11 communicates with the outside through the inlet mouth 12 and a position of closure in which the inlet mouth 12 is substantially closed by the foldable lug or flap 17.

The foldable flap 17 is preferably punched in order to allow passage of pressurized water for preparing coffee infusion when it takes the position of closure.

Steps (1) to (6) of the method of FIG. 1d therefore substantially coincide respectively with those ones (1) to (6) of the method of FIG. 1c, with the only exception that one of the steps (3), (4) or (5) of the method of FIG. 1d provides for the additional operation of folding or closing towards the inside the foldable lug or flap 17 of the disposable filtering insert 10.

Also in the case of this embodiment the most relevant advantages are related to the fact that:
the foldable flap 17 avoids unwanted spillages of powder coffee from the disposable filtering insert 10 before the application of the support assembly 30 of the improved filter 1 to the coffee machine M;
the foldable flap 17 eases filtering of hot water of preparation through the flap or cover 17;
the foldable flap (or cover) 17 prevents contact between the powder coffee and the parts of the coffee machine M positioned above the powder coffee during the preparation of coffee, thus averting that these parts get dirty or become contaminated by the organic residues involved in this operation (coffee wastes).

The improved filter 1, complete with filter disposable (or use-and-throw-away) intermediate filtering insert 10 and rigid main filtering body 20, of the present invention shown in FIGS. 2a to 2d coincides substantially with the improved filter respectively according to the embodiments represented in FIGS. 1a to 1d yet described.

The substantial difference between the embodiments of FIGS. 2a to 2d and those ones of FIGS. 1a to 1d is, indeed, related to the fact that in the first ones (FIGS. 2a-2d) the shape and dimensions of the disposable filtering insert 10 are substantially corresponding to those ones of a rigid filtering body 20 which is now suitable to coffee makers for domestic use, in particular the mocha-type coffee makers, rather than professional machines for espresso coffee M as in FIGS. 1a-1d.

Indeed, in this case the laminar side wall 13 is not tapered but extends from the laminar bottom 14 along a direction substantially perpendicular to the laminar bottom 14 itself.

Due to reasons of synthesis, it is omitted then a further detailed description of the embodiments of the improved filter 1 according to FIGS. 2a to 2d. However, for exposition completeness, it is stated precisely that each of the embodiments of FIGS. 2a-2d could comprise a portion of perimetrical extension 15 foldable toward the outside (FIG. 2a), and/or a perimetrical end portion 16 foldable or closable inwardly (FIGS. 2b and 2d) and/or a lug or flap or cover of shape and dimensions substantially corresponding to those ones of the inlet mouth 12 and suitable to be folded alternately between a position of closure and a position of opening (FIG. 2c).

Similarly, methods for the preparation of espresso coffee represented in FIGS. 2a-2d coincide substantially with those ones represented respectively in FIGS. 1a-1d whereby, even in this case, the detailed description opening for the sake of synthesis reasons.

It should be only noted that, in this case, the main rigid filtering body 20 is inserted according to methods known into the kettle 40 of the coffee maker, and that, at the end of the procedure of preparation of the coffee, organic residues (coffee wastes) can be disposed of together with the disposable intermediate filtering insert 10, for example by simply overturning the kettle 40 as shown in each of the FIGS. 2a-2d.

It should be also noted that even in the case of mocha-type coffee makers may be preferable to use of an improved filter 1 equipped with a disposable filtering insert which is frusto-conical, being in this case its filling with powder coffee simplified.

As already said, FIGS. 3a-3g show, by means of the plan view from the bottom of the disposable intermediate filtering insert 10, some preferred and optional embodiments of the separation means 18 associated with the laminar bottom 14.

In a preferred but not exclusive manner, the separation means 18 are uniformly and regularly distributed on the laminar bottom 14 of the disposable intermediate filtering insert 10, in such a way as to substantially follow the distribution of the filtering means belonging to the rigid main filtering body 20 and ease mass production of the filtering insert 10 itself. Even this constructive trick allows therefore the improved filter 1, while achieves the general prefixed purposes, to ensure the necessary creaminess to espresso coffee, without watering it down and impairing its taste.

According to the preferred embodiment of the invention, the separating means 18 include a plurality of through slots (or cuts, or holes, or apertures or the like) 19 made in the laminar bottom 14 and having dimensions such that to allow passage only of the infusion espresso coffee, in such a way that the organic residues resulting from the preparation of espresso coffee itself remain contained into the inner space 11 of the disposable filtering insert 10, supported by the upper surface 14a of the laminar bottom 14.

In particular, dimensions of the through slots 19 vary in directly proportional rate to the variation of the thickness of the laminar bottom 14 of the disposable intermediate filtering insert 10.

By way of pure example, it is highlighted that the dimensions of the through slots 19 have a value in the main size in the range of 0.2÷1.3 tenths of millimetre, preferably 0.6-0.8 tenths of millimetre.

Subsequent FIGS. 5-9 highlight another embodiment of the improved filter 1 of the invention which shows an additional advantageous constructive aspect.

Indeed, the main filtering body 20 includes adapter means, overall reported with 22, allowing the main filtering body 20 itself to removably receive into the inner seat 21 a single and well-defined model of disposable intermediate filtering insert 10 having shape and dimensions—height, thickness, diameter, and so on—which remain always the same with the variation of the type of coffee machine M.

More specifically, the adapter means 22 comprise one or more perimetrical strike walls 23 which are:
placed in the upper part of the main filtering body 20;
perimetrically projecting from a base portion 26 which includes the bottom 24 of the main filtering body 20 and presents a fixed shape and dimensions which remain unchanged with the variation of the type of espresso coffee machine;
surrounding the inlet opening 25 of the inner seat 21 which detachably receives the single model of disposable intermediate filtering insert 10 provided.

In function of what has just been said in reference to FIGS. 5-9, therefore, it is possible to mass-produce a single same model (or specimen) of disposable intermediate filtering insert 10—visible stand-alone in FIG. 9-, especially by moulding in case it is made of bioplastic material, and many rigid main filtering bodies 20 (two examples of which are illustrated in FIGS. 6 and 7), generally made of metallic material such as steel, as the different variants of the support assembly of the improved filter 1 (or the different solutions of espresso coffee machines) are available on the market, rather than the opposite, with the obvious economic production advantages that derive from that.

These main rigid filtering bodies 20 will differ each other for the shape and composition of the adapter means 22, while they will equal each other in respect to the shape, profile and dimensions of the base portion 26 and, specifically, of the inner seat 21, so that each of them will be able to house internally the same specimen of the disposable intermediate filtering insert 10.

It is emphasized that the different embodiments of the invention described up to now (with specific reference to the attached figures) provide that:
the rigid main filtering body 20 performs the actual filtering action of the coffee,
   while
the disposable intermediate filtering insert 10 has the function of retaining only the wastes of espresso coffee resulting from leaching of hot water—hence the adjective “filtering” associated with it, because in this way the disposable intermediate insert 10 performs however a filtering action-: in essence, therefore, the presence of such a disposable filtering insert 10 does not determine a negative dilution of the coffee infusion, which thus maintains the necessary creaminess, quality and aroma at the output of the main rigid filtering body 20, equivalent to those ones of a normal espresso coffee currently prepared, provided that the level of espresso coffee machines used is the same.

Since the improved filter of the invention ensures levels of cleaning of the coffee machine better greater than those ones ensured by the known art—net of performing continuous and accurate cleaning interventions of the coffee machine (also onerous, in case for example of a professional machine or a vending machine) rather rare and infrequent-, the improved filter of the invention, in combination with what has been said in the previous paragraph, produces espresso coffee of aroma, creaminess and quality better than those ones of a traditional espresso coffee which can today tasted.

It is understood that in other embodiments of the invention, not illustrated in the enclosed drawings, the improved filter claimed herein could provide a solution opposite to that one described above, namely that:
the rigid main filtering body (to be matched to the support element of the espresso coffee machine) performs a pure support action let just pass the infusion of espresso coffee—hence the adjective “filtering” associated with it, as thereby the rigid main filtering body still performs a filtering action-, but avoiding any dilution of the coffee infusion, which thus preserves the necessary creaminess, quality and aroma at the output;
the disposable intermediate filtering insert performs the action of effective filtration of the coffee.

Subject of the present invention is, as already mentioned, also a filtering kit for espresso coffee machines M.

In accordance with the peculiar features of the invention, the filtering kit comprises:
the rigid main filtering containment and/or support body 20 adapted to be coupled with a support element belonging to an espresso coffee machine M and shaped so as to define the inner seat 21 suitable to receive powder coffee;
a disposable intermediate filtering containment and/or retaining insert 10 made of food use material and:
   suitable to be removably coupled with the rigid main filtering body 20 by means of insertion, in the specific case almost complete, in the inner seat 21;
   shaped in such a way as to define the inner space 11 suitable to receive the powder coffee to be used in preparing espresso coffee by means of leaching of hot water, thus avoiding the contact between the powder coffee and the main filtering body 20;
   provided with a laminar bottom 14 in which the separation means 18 are defined suitable to favour passage of a coffee infusion produced by the leaching of hot water;
   suitable to be placed close to the support element of the coffee machine M in such a way as to be interposed between the main filtering body 20 and the support element itself of the espresso coffee machine M.

Based on the description just given, it is understood, therefore, that the improved filter for espresso coffee machines, object of the present invention, achieves the objects and realizes the advantages mentioned previously.

In particular, the inventive concept underlying the present invention allows to avoid the contact between the powder coffee and the parts of the espresso coffee machine or coffee maker usually appointed to contain it, whereby in the improved filter of the invention there is no need for cleaning operations—either ordinary or extraordinary—of the parties themselves, in particular the rigid main filtering body of coffee machine or coffee maker or of the support element—or shower—belonging to the latter.

Moreover, the disposable intermediate filtering insert according to the present invention does not require any changes to be made to the espresso coffee machines or coffee makers of common type, yet existing on the market.

In addition, emptying of the rigid main filtering body of the espresso machine or coffee maker can be particularly sped being, for example, enough for this purpose simply overturning the support assembly of the filter (in case of espresso coffee machines) and/or the rigid filter or kettle (in case of coffee makers), and then disposing of simultaneously both the organic residues (coffee wastes) and the disposable filtering insert in a proper container. The improved filter of the invention differs from the equivalent devices of the prior art by the fact, therefore, to be composite—disposable intermediate filtering insert combined with the rigid main filtering body—and for the fact that only the laminar bottom, and not even the laminar side wall, of the disposable filtering insert presents the separating means.

The presence of the disposable middle filtering insert in the improved filter of the invention does not hinder obtaining of an espresso coffee provides a traditional creaminess and quality, indeed, but, it allows to enhance these features offering clean conditions of the devices used for the preparation of espresso coffee improved compared to the current state of the art: its filtering capacity is therefore to be understood simply as ability to retain what is not useful for the purposes of an espresso coffee quality, leaving instead pass all that amount of coffee infusion which guarantees an excellent flavour to the same.

Although the improved filter has been reported by means of the detailed description of the embodiments of the present invention represented in the attached drawings, the present invention is not limited to the embodiments described and represented in them.

For instance, a variant of the embodiments shown respectively in FIGS. 1d and 2d provides that the foldable flap (or cover) is not bound with the body of the disposable middle filtering insert (in particular with its laminar side wall), but is rather detached and independent: in such a way, the foldable flap could be a will lay down on the powder coffee (so that to substantially close the inner space of the disposable filtering insert) or possibly be left out.

It is, finally, clear that several other changes could be made to the improved filter concerned, without departing from the principle of novelty intrinsic in the inventive idea expressed herein, as it is clear that, in the practical implementation of the invention, materials, shapes and sizes of the illustrated details could be changed, as needed, and replaced with others technically equivalent.

Where the constructive features and techniques mentioned in the following claims are followed by reference numbers or signs, those reference signs have been introduced with the sole objective of increasing the intelligibility of the claims themselves and therefore they have no limiting effect on the interpretation of each element identified, by way of example only, by these reference signs.

1-18. (canceled)

19. Improved filter (1) for espresso coffee machines (M) including a rigid main filtering containment and/or support body (20) suitable to be coupled with a support element belonging to an espresso coffee machine (M) and shaped in such a way as to define an inner seat (21) suitable to receive powder coffee, and a disposable middle filtering containment and/or retaining insert (10) made of food use material and:
removably coupled with said rigid main filtering body (20) by means of at least partly insertion into said inner seat (21);
shaped in such a manner as to define an inner space (11) which communicates with the outside through an inlet mouth (12) and is suitable to receive said powder coffee to be used in preparing said espresso coffee by means of leaching of hot water, avoiding contact between said powder coffee and said main filtering body (20);
provided with a laminar filtering bottom (14) in which separation means (18) are defined suitable to favour passing of a coffee infusion produced by means of said leaching of hot water;
suitable to be placed close to said support element of said coffee machine (M) in such a way as to interposed between said main filtering body (20) and said support element of said coffee machine (M),
characterized in that said separation means (18) include a plurality of open through slots (19) made in said laminar bottom (14) and having dimensions such to allow passage only of said coffee infusion, in such a way that organic residues resulting from the preparation of said espresso coffee remain contained into said inner space (11) of said disposable filtering insert (10), supported by said laminar bottom (14).

20. Filter (1) according to claim 19, characterized in that said food use material is biodegradable, compostable and/or disposable as organic waste compliant to standard In13432 regarding waste separate recycling.

21. Filter (1) according to claim 19, characterized in that said food use material is any plastic material for foods selected from the group consisting of recyclable bioplastic material, polylactic acid (PLA), low density polyethylene (LDPE), polyethylenterephthalate (PET), polyvinylchloride or chloride of polyvinyl (PVC), vinylester resins, silicone, elastomer, combinations thereof and/or similar.

22. Filter (1) according to claim 19, characterized in that said separation means (18) are uniformly and regularly distributed on said laminar bottom (14) of said disposable intermediate filtering insert (10), in such a way as to substantially follow the distribution of filtering means belonging to said rigid main filtering body (20) and ease mass manufacturing of said filtering insert (10).

23. Filter (1) according to claim 19, characterized in that said dimensions of said through slots (19) vary in directly proportional rate to the variation of the thickness of said laminar bottom (14) of said disposable middle filtering insert (10).

24. Filter (1) according to claim 19, characterized in that said dimensions of said through slots (19) present a value in the main size in the range of 0.2÷1.3 tenths of millemetre.

25. Filter (1) according to claim 19, characterized in that said disposable middle filtering insert (10) presents an infinitesimal thickness, such that the dose of said powder coffee contained into said inner space (11) takes a value recognized as necessary to give quality to said espresso coffee.

26. Filter (1) according to claim 25, characterized in that said thickness of said disposable middle filtering insert (10) presents a value equal to about 400 μm.

27. Filter (1) according to claim 19, characterized in that said disposable middle filtering insert (10) presents a profile corresponding and combinable with the profile of said rigid main filtering body (20).

28. Filter (1) according to claim 19, characterized in that said disposable middle filtering insert (10) comprises a laminar side wall (13) extending upwardly starting from the outer perimetrical edge of said laminar bottom (14) and, together with said laminar bottom (14), defining said inner space (11) communicating with the outside through an inlet mouth (12) opposite to said laminar bottom (14) and defined by said laminar side wall (13).

29. Filter (1) according to claim 28, characterized in that said disposable middle filtering insert (10) comprises a portion of perimetrical extension (15) which:
extends from an upper edge (13a) of said laminar side wall (13) opposite to a lower edge (13b) connected with said outer perimetrical edge of laminar bottom (14);
is foldable towards the outside in such a way as to be superimposed to the outer edge of said rigid main filtering body (20) and at least partly extend outside said rigid main filtering body (20) and thus operate as sealing gasket when said improved filter (1) is in operative conditions, placing itself close to said support element of said espresso coffee machine (M).

30. Filter (1) according to claim 29, characterized in that said portion of perimetrical extension (15) is foldable along weakening means arranged at said upper edge (13a) of said laminar side wall (13).

31. Filter (1) according to claim 28, characterized in that said laminar side wall (13) of said disposable filtering insert comprises:
a perimetrical proximity portion extending upwardly from the outer petrimetrical edge of said laminar bottom (14);
a perimetrical end portion (16) extending from said perimetrical proximity portion with respect to which is movable between a closure position where it substantially closes said inner space (11) and an opening position where said inner space (11) communicates with the outside through said inlet mouth (12), being so suitable to house said powder coffee.

32. Filter (1) according to claim 31, characterized in that said laminar side wall (13) comprises weakening means along which said perimetrical end portion (16) is alternately foldable between said closure position and said opening position with respect to said perimetrical proximity portion.

33. Filter (1) according to claim 19, characterized in that said rigid main filtering body (20) include adapter means (22) suitable to allow said main filtering body (20) to removably receive into said inner seat (21) a single model of said disposable middle filtering insert (10) having shape and dimensions which remain always the same with the variation of the type of said coffee machine (M).

34. Filter (1) according to claim 33, characterized in that said adapter means (22) comprise one ore more perimetrical strike walls (23) which are:
placed in the upper part of said main filtering body (20);
perimetrically projecting from a base portion (26) which comprises the bottom (24) of said main filtering body (20) and presents fixed shape and dimensions which remain unchanged with the variation of the type of said espresso coffee machine;
surrounding the inlet opening (25) of said inner seat (21) which removably receives said single model of said disposable middle filtering insert (10).

35. Filtering kit for espresso coffee machines (M) comprising:
a rigid main filtering containment and/or support body (20) suitable to be coupled with a support element belonging to an espresso coffee machine (M) and shaped in such a way as to define an inner seat (21) suitable to receive powder coffee;
a disposable middle filtering containment and/or retaining insert (10) made of food use material and:
suitable to be removably coupled with said rigid main filtering body (20) by means of at least partly insertion into said inner seat (21);
shaped in such a manner as to as to define an inner space (11) which communicates with the outside through an inlet mouth (12) and is suitable to receive said powder coffee to be used in preparing said espresso coffee by means of leaching of hot water, avoiding contact between said powder coffee and said main filtering body (20);
provided with a laminar bottom (14) in which separation means (18) are defined suitable to favour passing of a coffee infusion produced by means of said leaching of hot water;
suitable to be placed close to said support element of said coffee machine (M) in such a way as to be interposed between said main filtering body (20) and said support element of said espresso coffee machine (M),
characterized in that said separation means (18) include a plurality of open through slots (19) made in said laminar bottom (14) and having dimensions such to allow passage only of said coffee infusion, in such a way that organic residues resulting from the preparation of said espresso coffee remain contained into said inner space (11) of said disposable filtering insert (10), supported by said laminar bottom (14).
